(19) United States
(12) Patent Application Publication
(10) Pub. No.: US 2023/0143717 A1
(43) Pub. Date: May 11, 2023

(54) METHOD FOR PROVIDING INTERACTIVE COMPUTING SERVICE FOR ARTIFICIAL INTELLIGENCE PRACTICE

(71) Applicant: COMMON COMPUTER INC., Seoul (KR)

(72) Inventors: Minhyun KIM, Seoul (KR); Dongil SEO, Seoul (KR); Donghyeon CHOI, Uijeongbu-si (KR); Seonghwa YUN, Seongnam-si (KR)

(21) Appl. No.: 17/535,959

(22) Filed: Nov. 26, 2021

(30) Foreign Application Priority Data
Nov. 5, 2021 (KR) 10-2021-0151133

(51) Int. Cl. G06F 8/36; G06N 20/00

(52) U.S. Cl. CPC G06F 8/36; G06N 20/00

(57) ABSTRACT

A method for providing an interactive computing service for artificial intelligence practice is provided, in which the method is performed by at least one processor and includes outputting, by a user client, a plurality of open source codes for artificial intelligence practice, receiving, by the user client, a request to run one of the plurality of open source codes, and outputting, by the user client, an execution result of the one open source code which is generated by using an image associated with the one open source code in response to receiving the request to run.

### CROSS-REFERENCE TO RELATED APPLICATION

This application claims priority under 35 U.S.C § 119 to Korean Patent Application No. 10-2021-0151133 filed in the Korean Intellectual Property Office on Nov. 5, 2021, the entire contents of which are hereby incorporated by reference.

### TECHNICAL FIELD

The present disclosure relates to a method for providing an interactive computing service for artificial intelligence practice, and more particularly, to a method for providing an interactive computing service for outputting an execution result of open source code, in which the execution result of open source code is generated by using a container image associated with one open source code, which is requested to run, among a plurality of open source codes provided for artificial intelligence-related programming practice.

### BACKGROUND

In general, many open source projects are shared through services (e.g., ‘GitHub ’) that provide source code hosting and sharing functions. In addition, through these services, developers can focus on development tasks that can create new value based on existing source codes without the need to develop new source codes from scratch.

However, more than tens of millions of new open source repositories are created every year, and the runtime environments such as operating systems, programming languages, libraries, framework, and the like required to run the source code of each open source project are becoming more diverse. In particular, in the case of projects related to artificial intelligence or machine learning, it is also necessary to consider the hardware execution environment according to various combinations of CPU, GPU, memory, main board, cooling device, power supply, and the like for compatibility with the source code runtime environment.

For these reasons, a source code developer or a source code programming learner needs to spend more time and effort in building the execution environment that can run the source code, than the time and effort spent on source code development or programming practice itself. In addition, it requires a considerable amount of cost for an AI-related source code developer or source code programming learner to directly prepare the execution environment and run the machine learning task.

### SUMMARY

In order to solve the problems described above, the present disclosure provides a method and a system for providing an interactive computing service for outputting an execution result of open source code, in which the execution result of open source code is generated by using a container image associated with one open source code, which is requested to run, among a plurality of open source codes provided for artificial intelligence-related programming practice.

According to an embodiment of the present disclosure, a method for providing an interactive computing service for artificial intelligence practice is provided, in which the method is performed by at least one processor and includes outputting, by a user client, a plurality of open source codes for artificial intelligence practice, receiving, by the user client, a request to run one of the plurality of open source codes, and outputting, by the user client, an execution result of the one open source code which is generated by using an image associated with the one open source code in response to receiving the request to run.

According to an embodiment, the image may include an image built in advance based on at least some of a plurality of open source codes by a manager node associated with the user client.

According to an embodiment, the outputting, by the user client, an execution result of the one open source code which is generated by using an image associated with the one open source code in response to receiving the request to run may include calculating, by a service platform, computing resource information for running the open source code in response to receiving the request to run, receiving, by the service platform, the execution result from one or more worker nodes determined based on the calculated computing resource information, transmitting, by the service platform, the received execution result to the user client, and outputting, by the user client, the execution result.

According to an embodiment, the receiving, by the user client, a request to run one of the plurality of open source codes may include receiving, by the user client, a request to run the one open source code and a selection for a path to run the one open source code.

According to an embodiment, the path to run the one open source code may include a shared storage and a personal storage associated with a plurality of images built in advance based on at least some of the plurality of open source codes.

According to an embodiment, the shared storage may be configured such that the user client can read one open source code, and the personal storage may be configured such that the user client can read or write one open source code.

According to an embodiment, the computing resource information may include information on at least one of a processor specification necessary to run the image, whether or not graphics processing is supported, and storage capacity.

According to an embodiment, the receiving, by the service platform, the execution result from one or more worker nodes determined based on the calculated computing resource information may include allocating, by a manager node, work for running the image to one or more worker nodes that satisfy the computing resource information and receiving, by the manager node, the execution result from the one or more worker nodes.

According to an embodiment, a plurality of worker nodes associated with the manager node may include the one or more worker nodes, and the allocating, by the manager node, work for running the image to one or more worker nodes that satisfy the computing resource information may include allocating, by the manager node, the task to one or more worker nodes of the plurality of worker nodes based on at least one of a delay in communication, a cost for performing the task, and reliability of each of the plurality of worker nodes.

According to another embodiment, a computer program is provided, which is stored on a computer-readable recording medium for executing, on a computer, the method for providing an interactive computing service for artificial intelligence practice.

According to still another embodiment, a system for providing an interactive computing service for artificial intelligence practice is provided, in which the system may include a user client, the user client may include at least one processor, and the at least one processor may include instructions for outputting a plurality of open source codes for artificial intelligence practice, receiving a request to run one of the plurality of open source codes, and in response to receiving the request to run, outputting an execution result of the one open source code which is generated by using a container associated with the one open source code.

According to various embodiments of the present disclosure, the source code developer or programming learner can run the source code or obtain the execution result by utilizing the resources provided from various nodes without the need to directly configure the source code execution environment.

According to various embodiments of the present disclosure, compared to the conventional centralized cloud-based system, users can significantly reduce the cost required for learning or practicing artificial intelligence-related programming and can also reduce the construction time of the source code development environment related to machine learning tasks.

According to various embodiments, the user can run and/or distribute the source code stored in the code repository by simply inputting the link address of the code repository in the interactive computing system, and execute and/or use the work result.

According to various embodiments of the present disclosure, the manager node of the interactive computing system may determine an optimal worker node in consideration of various factors for processing the request to run open source from a client or a service platform.

The effects of the present disclosure are not limited to the effects described above, and other effects not described will be able to be clearly understood by those of ordinary skill in the art (hereinafter, referred to as “ordinary technician”) from the description of the claims.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawing, in which:

FIG. 1 illustrates an example in which a user uses an interactive computing service according to an embodiment;

FIG. 2 illustrates an example of an interactive computing system for artificial intelligence practice according to an embodiment;

FIG. 3 is a schematic diagram illustrating a configuration in which a service platform is communicatively connected to a plurality of user clients to provide an interactive computing service in conjunction with a code repository according to an embodiment;

FIG. 4 illustrates an example in which a manager node builds an image according to an embodiment;

FIG. 5 is a block diagram illustrating a configuration of a node pool according to an embodiment;

FIG. 6 is a block diagram illustrating a configuration of a container execution environment according to an embodiment;

FIG. 7 is a flowchart illustrating a method for providing an interactive computing service according to an embodiment; and

FIG. 8 is a flowchart illustrating a method for providing an interactive computing service according to another embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding components may be omitted. However, even if descriptions of components are omitted, it is not intended that such components are not included in any embodiment.

The terms used in the present disclosure will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the embodiments. Therefore, the terms used in the present disclosure should be defined based on the meaning of the terms and the overall content of the present disclosure rather than a simple name of each of the terms.

In the present disclosure, the singular forms “a,” “an,” and “the” are intended to include the plural forms as well, unless the context clearly indicates the singular forms. Further, the plural forms are intended to include the singular forms as well, unless the context clearly indicates the plural forms.

In the present disclosure, when a portion is stated as “comprising (including)” a component, unless specified to the contrary, it intends to mean that the portion may additionally comprise (or include or have) another component, rather than excluding the same.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the present embodiments are merely provided to make the present disclosure complete, and to fully disclose the scope of the invention to those skilled in the art to which the present disclosure pertains.

In the present disclosure, the “system” may refer to at least one of a server device and a cloud device, but not limited thereto. For example, the system may include one or more server devices. In another example, the system may include one or more cloud devices. In another example, the system may include both the server device and the cloud device operated in conjunction with each other.

In the present disclosure, a “code repository” may include a repository configured to store, update, share, or manage one or more source codes and/or files developed or generated by various developers. Alternatively, the “code repository” may refer to one or more source codes and/or files themselves contained in the code repository.

In the present disclosure, an “image” may represent binary data encapsulating an application capable of executing instructions according to source code and data associated with the application (e.g., server program, source code and library, compiled executable file, and the like). It is possible to run the image having this configuration in the runtime environment, and the result of running the image may be referred to as a “container”. The container includes a minimum element for running the image, and may include a virtual machine that enables to independently deploy and run the image.

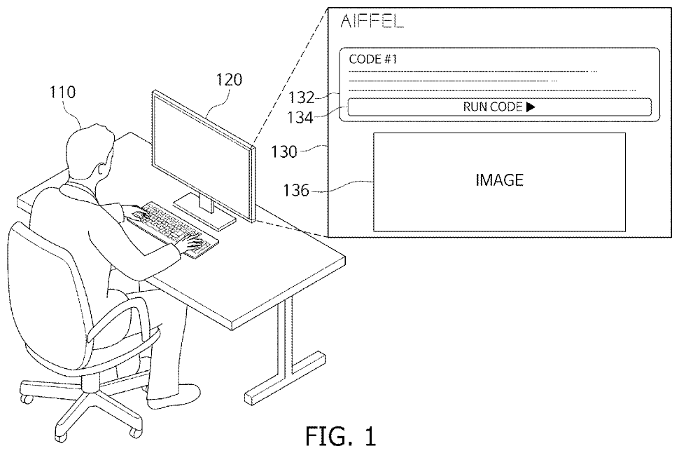

FIG. 1 illustrates an example in which a user 110 uses an interactive computing service according to an embodiment. As illustrated, the user 110 may use the interactive computing service by using a user client 120 (or user terminal). According to an embodiment, the user 110 may check a plurality of open source codes through a user interface 130 provided by the service platform and select an open source code 132 for artificial intelligence practice.

According to an embodiment, the user 110 may select a button 134 to request to run the selected open source code 132 and be provided with an execution result 136 (or the work result) of the open source code 132. In this case, the execution (or work) of the open source code 132 may be performed by a separate computing device (not illustrated) for the execution of the open source code 132, rather than by the user client 120. In this case, the separate computing device may refer to a computing device that satisfies computing resource information (e.g., processor specifications, whether or not graphics processing is supported, storage capacity, and the like) for running the selected open source code 132.

Specifically, when the user 110 selects the button 134 to request to run, the service platform providing the interactive computing service may calculate computing resource information for running the open source code 132. Then, a computing device (e.g., a worker node) that satisfies the calculated computing resource information may be determined, and work of running the open source code 132 may be allocated to the determined computing device. The computing device allocated with the work may run the open source code 132, and the execution result 136 may be finally transmitted to the user client 120 to be provided to the user 110.

With this configuration, the source code developer or user 110 can run the source code or obtain the execution result 136 by utilizing the resources provided from various nodes without the need to directly configure the source code execution environment. Accordingly, compared to the existing centralized cloud, the user 110 can significantly reduce the cost of using computing resources for the purpose of practicing or programming related to machine learning task, and also reduce the time required for constructing the source code development environment related to machine learning task. In addition, the user 110 can effectively execute practicing and programming learning related to the machine learning task, without specialized knowledge in setting and allocating computing resources related to the machine learning task.

According to an embodiment, the user 110 may select a path to run the open source code 132 through the user interface 130. In this example, the path to run the open source code 132 may include a shared storage and a personal storage. The shared storage as used herein refers to a repository where a plurality of users store the open source codes or the execution results of the open source codes, and it is not possible to modify or change the open source codes or its execution results stored in the shared storage, but use for reference only. On the other hand, the personal storage is a code repository allocated to a specific user, and the specific user can modify or change the open source codes or its execution results stored in the personal storage as needed. Accordingly, when the user 110 selects the shared storage for the path to run the open source code 132, the user client 120 may read the open source code 132 stored in the shared storage. That is, the user 110 cannot change the open source code 132 through the user client 120. On the other hand, when the user 110 selects the personal storage for the path to run the open source code 132, the user client 120 is able to read or change the open source code 132. That is, the user 110 may change some of the open source code 132 through the user client 120, and may be provided with the execution result 136 reflecting the change.

According to an embodiment, images of a plurality of open source codes provided through the user interface 130 (e.g., container images or images of virtualization nodes) may be built and stored in advance. For example, a manager node providing the interactive computing service may build, through a separate build server, images of a plurality of open source codes provided through the service platform and store the built images in advance. In this example, the image may include not only the source code but also all files and setting values necessary for running the source code, and upon running the image, a container that is work result of the source code may be generated.

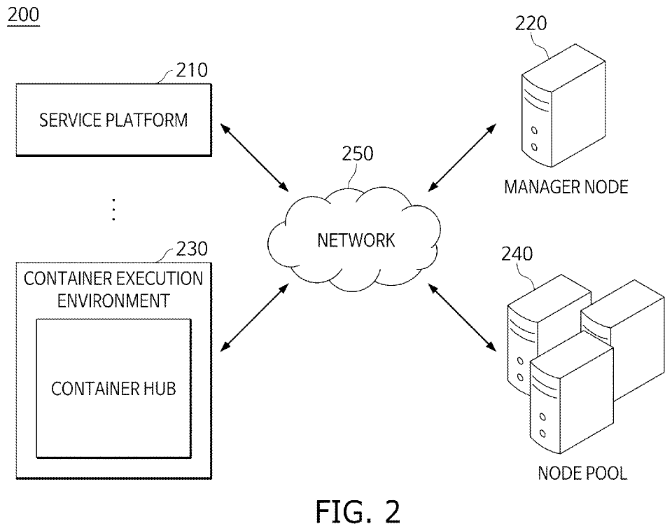

FIG. 2 illustrates an example of an interactive computing system for artificial intelligence practice according to an embodiment. As illustrated, the interactive computing system may include a service platform 210, a manager node 220, a container execution environment 230, and a node pool 240, to provide an interactive computing service. In addition, a network 250 may be configured to enable communication between the service platform 210, the manager node 220, the container execution environment 230, and/or the node pool 240.

According to an embodiment, the service platform 210 may include a Machine Learning as a Service (MLaaS) platform capable of, based on the link address (e.g., URL addresses received from users or clients, and the like) of the code repository, extracting the specification of system resources necessary to distribute the artificial intelligence-related source code included in the code repository, and allocating the resources of the computing system in accordance with the extracted specification to distribute the corresponding source code. For example, the service platform 210 may analyze the source code included in the code repository selected by the user client, calculate computing resource information necessary to run the work associated with the source code, and transmit the calculated computing resource information to the manager node 220. In this example, the computing resource information may include a specification of a processor required to run the work associated with the source code, whether or not graphics processing is supported, a storage capacity, and the like. In addition, the work associated with the source code may include generating a container by running an image associated with the source code. With this configuration, the user can run and/or distribute the source code stored in the code repository by simply inputting the link address of the code repository in the interactive computing system, and execute and/or use the work result.

According to an embodiment, the manager node 220 may allocate work for the source code to one or more worker nodes included in the node pool 240 according to a work request of the service platform 210. For example, the manager node 220 may determine a plurality of worker nodes that satisfy the computing resource information received from the service platform 210, and allocate work for the source code to one or more worker nodes among the plurality of worker nodes based on delay in communication, cost for performing work and reliability, and the like of each of the plurality of worker nodes. As another example, the manager node 220 may calculate the computing resource information necessary to run the work associated with the source code based on the information on the source code received from the service platform 210, and allocate the work to one or more worker nodes that satisfy the calculated computing resource information. As another example, the manager node 220 may allocate the work for the source code to one or more worker nodes among the plurality of worker nodes according to the selection of the user client. Meanwhile, when one or more worker nodes cannot perform the work allocated from the manager node 220, the manager node 220 may reallocate the corresponding work to another worker nodes among the plurality of workers.

According to an embodiment, one or more worker nodes included in the node pool 240 may perform the work allocated from the manager node 220. For example, one or more worker nodes may perform the allocated work in a container-based runtime execution environment. Then, the manager node 220 may receive information on the work results of the work performed from one or more worker nodes, and transmit at least some of the information on the received work results to the service platform 210. In this case, the service platform 210 may transmit at least some of the information on the work results received from the manager node 220 back to the user client such that a user interface to check or execute the work results is output through the user client.

According to an embodiment, the manager node 220 may determine or update the reliability of each of the plurality of worker nodes based on activity details of each of the plurality of worker nodes included in the node pool 240. For example, the manager node 220 may update the reliability of the worker node such that the reliability of the worker node that performed the allocated work is increased, while the manager node 220 may update the reliability of the worker node such that the reliability of the worker node that does not perform or fails to perform the allocated work is decreased. As another example, each of the plurality of worker nodes included in the node pool 240 may periodically transmit a message to the manager node 220 informing that it is operated normally. In this case, the manager node 220 may update the reliability of the worker node such that the reliability of the worker node that does not transmit the message for a predetermined period or more is decreased. The reliability of each of the plurality of worker nodes included in the node pool 240 may be taken into consideration when the manager node 220 and/or the user client selects a worker node to allocate the work to. For example, the manager node 220 may allocate work to one or more worker nodes of the plurality of worker nodes, in which the one or more worker nodes have reliability higher than a predetermined reference value.

With this configuration, the manager node 220 of the interactive computing system may consider various factors to determine an optimal worker node to process the work request from the client or service platform. The reliability of the worker node determined according to various factors eventually becomes an important factor when the client selects a node to process its request, and worker nodes with low reliability are not normally assigned with tasks. Accordingly, each asset provider node or worker nodes in the system can be induced to perform work in such a way as to improve its reliability.

FIG. 2 illustrates a configuration in which the service platform 210, the manager node 220, the container execution environment 230, and the node pool 240 are connected to each other through the network 250 in order to provide an interactive computing service for artificial intelligence practice, although embodiments are not limited thereto. For example, certain components may be omitted or other components may be further added. In addition, FIG. 1 illustrates that three worker nodes are included in the node pool 240, but embodiments are not limited thereto, and a different number of worker nodes may be included in the node pool 240.

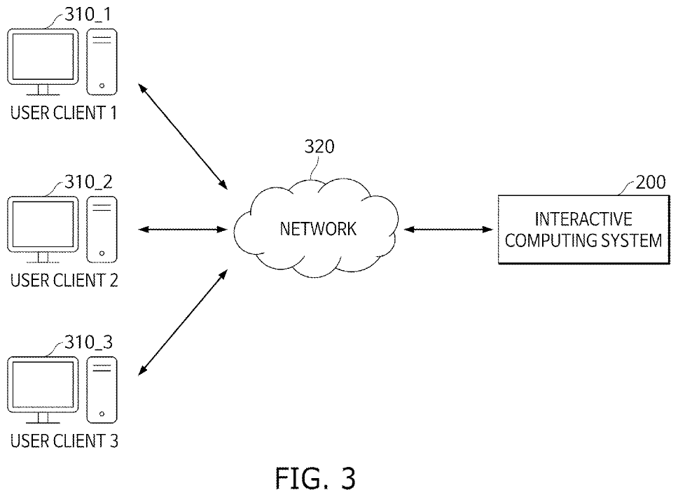

FIG. 3 is a schematic diagram illustrating a configuration in which an interactive computing system 200 is communicatively connected to a plurality of user clients 310_1, 310_2, and 310_3 to provide an interactive computing service in conjunction with a code repository according to an embodiment. The interactive computing system 200 may include a system(s) capable of providing an interactive computing service. According to an embodiment, the interactive computing system 200 may include one or more server devices and/or databases capable of storing, providing and executing computer-executable programs (e.g., downloadable applications) and data associated with the interactive computing service, or one or more distributed computing devices and/or distributed databases based on cloud computing services. For example, the interactive computing system 200 may include separate systems (e.g., server, computing device) for providing the interactive computing service. In another example, the interactive computing system 200 may include the service platform, the manager node, the node pool, the container hub, and the like connected to each other through the network as illustrated in FIG. 2.

A plurality of user clients 310_1, 310_2, and 310_3 may communicate with the manager node (e.g., 220 of FIG. 2) through a network 320. After accessing the service platform through the user clients 310_1, 310_2, and 310_3, the user may select the source code stored in the code repository. When the user selects the source code using the user clients 310_1, 310_2, and 310_3, the manager node may search for a worker node that satisfies a condition (e.g., computing resource information) necessary for running the source code selected by the user from the node pool (e.g., 240 in FIG. 2). When a worker node capable of running the source code is found, the source code may be executed through the node, and the user may check the execution result of the source code through the user clients 310_1, 310_2, and 310_3.

The interactive computing service provided by the interactive computing system 200 may be provided to the user through an application and the like for the interactive computing service installed in each of the plurality of user clients 310_1, 310_2, and 310_3. Alternatively, the user clients 310_1, 310_2, and 310_3 may process the work such as source code analysis, computing resource information calculation, and the like, using interactive computing service program/algorithm stored therein. In this case, the user clients 310_1, 310_2, and 310_3 may directly process the work such as source code analysis, computing resource information calculation, and the like without communicating with the interactive computing system 200.

The plurality of user clients 310_1, 310_2, and 310_3 may communicate with the interactive computing system 200 through the network 250. The network 250 may be configured to enable communication between the plurality of user clients 310_1, 310_2, and 310_3 and the interactive computing system 200. The network 250 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and so on) that may be included in the network 250 as well as short-range wireless communication between the user clients 310_1, 310_2 and 310_3.

FIG. 3 illustrates PC terminals as an example of the user clients 310_1, 310_2, and 310_3, but the present disclosure is not limited thereto, and the user clients 310_1, 310_2, and 310_3 may be any computing device capable of wired and/or wireless communication. For example, the user client may include a smart phone, a mobile phone, a computer, a notebook computer, a personal digital assistant (PDA), a portable multimedia player (PMP), a tablet PC, and the like. In addition, FIG. 2 illustrates that the three user clients 310_1, 310_2, and 310_3 are in communication with the interactive computing system 200 through the network 250, but embodiments are not limited thereto, and a different number of user clients may be configured to be in communication with the interactive computing system 200 through the network 250.

In an embodiment, the interactive computing system 200 may receive data (e.g., the link address of the code repository, the source code included in the code repository, and the like) from the user clients 310_1, 310_2, and 310_3 through an application and the like for the interactive computing service running on the user clients 310_1, 310_2, and 310_3. In addition, the interactive computing system 200 may transmit the information on work result to the user clients 310_1, 310_2, and 310_3, so that the user clients 310_1, 310_2, and 310_3 output a user interface to execute the work result. When the user clients 310_1, 310_2, and 310_3 use the interactive computing system 200 to operate a machine learning task or execute an artificial intelligence practice, it is possible to reduce operation or practice cost and reduce the time to build the environment for machine learning development.

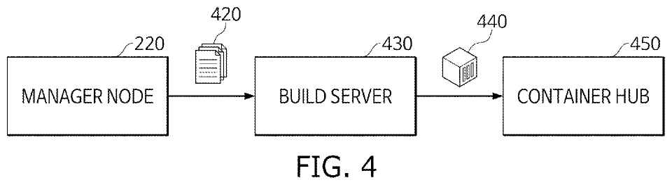

FIG. 4 illustrates an example in which the manager node 220 builds an image 440 according to an embodiment. As illustrated, the manager node 220 may build the image 440 through a build server 430 using a docker file 420. For example, the manager node 220 may build the image 440 through the build server 430 using the docker file 420 of the source code stored in the code repository. The docker file 420 may herein refer to a single file in which package, source code, script, and the like necessary for building the image 440 are recorded as text. For example, class requirements associated with artificial intelligence practice may be recorded as text in the docker file 420.

According to an embodiment, the manager node 220 may push the built image 440 and store it in a container hub 450. The image 440 may herein refer to a file used to generate the container. The manager node 220 may allocate a run for an image of a source code selected by the user through the service platform (e.g., 210 in FIG. 2) from among a plurality of images stored in the container hub to one or more worker nodes included in the node pool (e.g., 240 in FIG. 2).

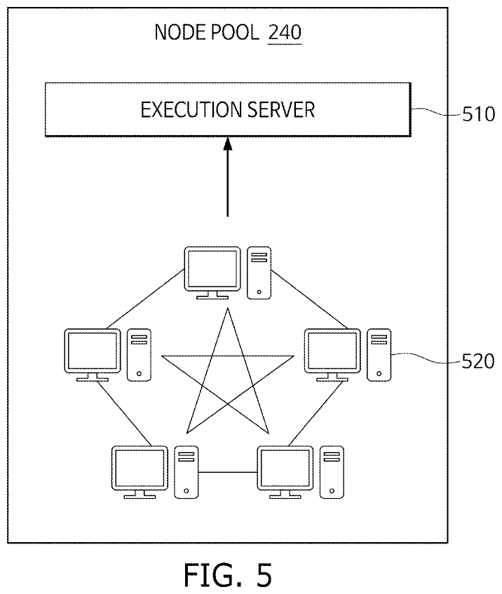

FIG. 5 is a block diagram illustrating a configuration of the node pool 240 according to an embodiment. As illustrated, the node pool 240 may include an execution server 510 and a plurality of worker nodes 520. The execution server 510 may duplicate the source code in order to perform work for the source code selected by the user through the service platform (e.g., 210 of FIG. 2). Then, the execution server 510 may manage the node pool 240 such that the corresponding source code is executed in the worker node allocated with the work for the selected source code, among the plurality of worker nodes 520.

According to an embodiment, instead of a centralized management system, each of the plurality of worker nodes 520 may be configured in a structure of a peer-to-peer (P2P) network system in which each of the interconnected worker nodes share resources with each other. Accordingly, the worker nodes allocated with the work by the manager node may be connected to each other. As described above, the connected worker nodes provide an environment in which containerized source code can be downloaded to the corresponding worker nodes and directly executed, and the user can be provided with the execution result of the source code from the worker nodes.

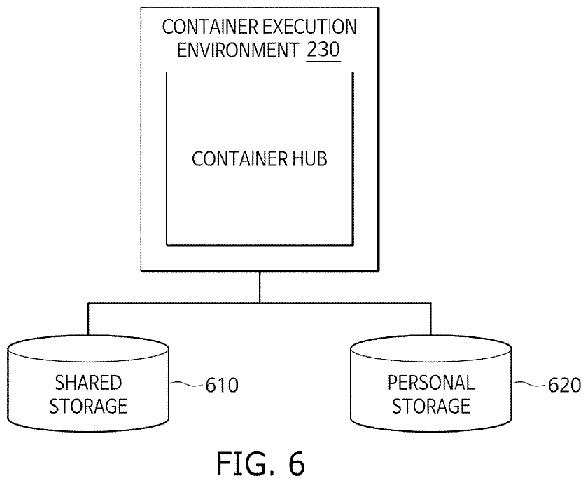

FIG. 6 is a block diagram illustrating a configuration of the container execution environment 230 according to an embodiment. According to an embodiment, the container execution environment 230 may include the container hub 450 storing an image (e.g., 440 of FIG. 4) built based on the source code stored in the code repository. In addition, the container execution environment 230 may be connected to storages 610 and 620. Here, the storages 610 and 620 may refer to an area storing a dataset (e.g., a container generated by running an image) necessary in relation to each of a plurality of artificial intelligence practices provided to a user through the service platform (e.g., 210 in FIG. 2).

Specifically, for example, when the user logs in to the service platform (e.g., 210 in FIG. 2) and participates in artificial intelligence practice, a virtual machine implemented as a kubernetes container is generated, and the user can access the virtual machine to perform artificial intelligence practice. At this time, the shared storage 620 or the individual storage 630 is mounted on the generated virtual machine, and the user may perform artificial intelligence practice using the dataset stored in each of the shared storage 620 or the individual storage 630. For example, the shared storage 620 may be mounted on the virtual machine as read-only. In this case, the user can only refer to the dataset stored in the shared storage 620 and cannot change the dataset. As another example, the individual storage 630 may be mounted on a virtual machine to enable both read/write. In this case, the user can add data to the individual storage 630 or change the already-stored dataset, and the added data, or changed dataset as described above remains permanently in the individual storage 630 even when the user logs out of the service platform and the Kubernetes container is destroyed.

According to an embodiment, when a user requests to execute the work related to the source code through the service platform (that is, when running an image associated with the source code to generate container), the user may set the storage path. For example, when the user requests to execute the work related to the source code, the user may set the shared storage 620 or the individual storage 630 as the path of the storage for storing the generated container.

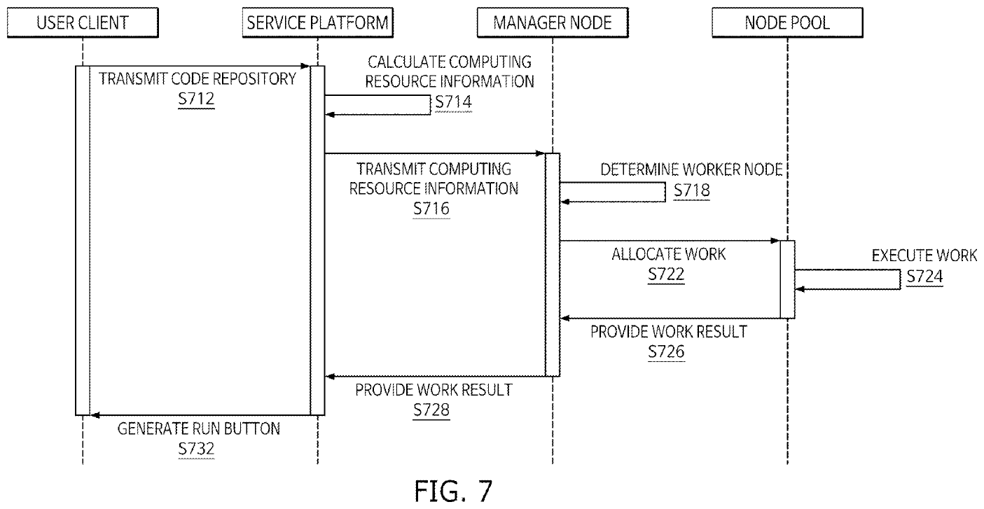

FIG. 7 is a flowchart illustrating a method 700 for providing an interactive computing service according to an embodiment. The user client may provide information on the code repository to the service platform, at S712. Here, the information on the code repository may include a link address (e.g., URL address) of the code repository selected by the user, a file and/or source code included in the code repository or a link address thereof. The service platform may analyze the file and/or source code included in the code repository, calculate the computing resource information necessary to execute the work associated with the source code, at S714, and transmit the calculated computing resource information to the manager node, at S716.

The manager node may determine one or more worker nodes that satisfy the received computing resource information, among a plurality of worker nodes included in the node pool, at S718. The manager node may allocate the work to one or more worker nodes determined at S718, at S722. One or more worker nodes allocated with the work among a plurality of worker nodes included in the node pool may perform the allocated work, at S724 and provide information on the work result to the manager node, at S726. The manager node may provide information on the work result received from the worker node to the service platform, at S728, and the service platform may instruct the user client to generate a user interface for outputting the work result (e.g., “run” button of the work result), at S732. That is, when the user selects one source code included in the code repository through the user client, the user may be provided with a user interface for checking the execution result of the source code generated according to the method 700. When the user selects the run button on the user interface provided as described above, the result of running the source code selected by the user is output immediately.

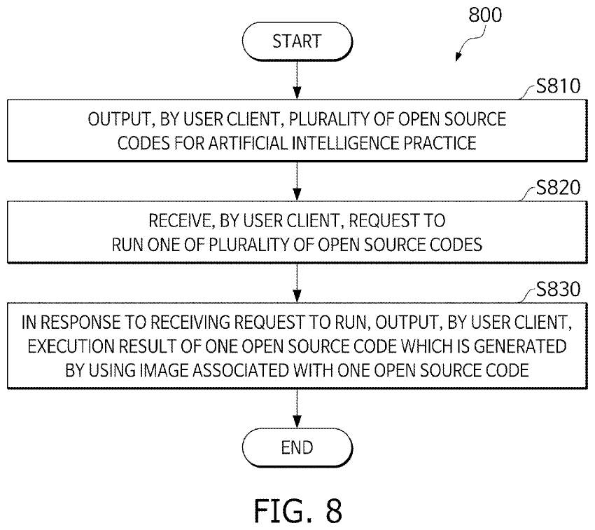

FIG. 8 is a flowchart illustrating a method 800 for providing an interactive computing service according to another embodiment. The method 800 may be performed by at least one processor of a user client (or user terminal). As illustrated, the method 800 may be initiated by the user client outputting a plurality of open source codes for artificial intelligence practice, at S810. Then, by the user client, it is possible to receive a request to run one of a plurality of open source codes, at S820, and in response to receiving the request to run, output an execution result of the open source code which is generated by using an image associated with the one open source code, at S830. Here, the receiving, by the user client, the request to run one of a plurality of open source codes at S820 may correspond to receiving information on the code repository from the user client (e.g., 712 in FIG. 7). In addition, the image may include an image built in advance based on at least some of a plurality of open source codes by a manager node associated with the user client.

According to an embodiment, by the service platform, it is possible to calculate computing resource information for running the open source code in response to receiving the request to run. Then, by the service platform, it is possible to receive the execution result from one or more worker nodes determined based on the calculated computing resource information, transmit the received execution result to the user client, and output, by the user client, the received execution result. In this example, the computing resource information may include information on at least one of a processor specification necessary to run the image, whether or not graphics processing is supported, and storage capacity.

According to an embodiment, by the user client, it is possible to receive a request to run one open source code and a selection for the path to run the one open source code. In this case, the path to run one open source code may include shared storage and personal storage associated with a plurality of images built in advance based on at least some of the plurality of open source codes. In addition, the shared storage may be configured such that the user client can read one open source code, and the personal storage may be configured such that the user client can read or write one open source code.

According to an embodiment, by the manager node, it is possible to allocate work for running the image to one or more worker nodes that satisfy the computing resource information. Then, by the manager node, it is possible to receive execution results from one or more worker nodes. Additionally, a plurality of worker nodes associated with the manager node may include one or more worker nodes, and by the manager node, it is possible to allocate work to one or more worker nodes of the plurality of worker nodes based on at least one of delay in communication, cost for performing the task, and reliability of each of the plurality of worker nodes.

The method for providing an interactive computing service described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

The above description of the present disclosure is provided to enable those skilled in the art to make or use the present disclosure. Various modifications of the present disclosure will be readily apparent to those skilled in the art, and the general principles defined herein may be applied to various modifications without departing from the spirit or scope of the present disclosure. Thus, the present disclosure is not intended to be limited to the examples described herein but is intended to be accorded the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the present disclosure has been described in connection with some embodiments herein, it should be understood that various modifications and changes can be made without departing from the scope of the present disclosure, which can be understood by those skilled in the art to which the present disclosure pertains. In addition, such modifications and changes should be considered within the scope of the claims appended herein.

1. A method for providing an interactive computing service for artificial intelligence practice, the method performed by at least one processor and comprising:
outputting, by a user client, a plurality of open source codes for artificial intelligence practice;
receiving, by the user client, a request to run one of the plurality of open source codes; and
outputting, by the user client, an execution result of the one open source code which is generated by using an image associated with the one open source code in response to receiving the request to run.

2. The method according to claim 1, wherein the image is built in advance based on at least some of the plurality of open source codes by a manager node associated with the user client.

3. The method according to claim 1, wherein the receiving, by the user client, a request to run one of the plurality of open source codes includes:
receiving, by the user client, a request to run the one open source code and a selection for a path to run the one open source code.

4. The method according to claim 3, wherein the path to run the one open source code includes a shared storage and a personal storage associated with a plurality of images built in advance based on at least some of the plurality of open source codes.

5. The method according to claim 4, wherein the shared storage is configured such that the user client can read the one open source code, and the personal storage is configured such that the user client can read or write the one open source code.

6. The method according to claim 1, wherein the outputting, by the user client, an execution result of the one open source code which is generated by using an image associated with the one open source code in response to receiving the request to run includes:
calculating, by a service platform, computing resource information for running the open source code in response to receiving the request to run;
receiving, by the service platform, the execution result from one or more worker nodes determined based on the calculated computing resource information;
transmitting, by the service platform, the received execution result to the user client; and
outputting, by the user client, the execution result.

7. The method according to claim 6, wherein the receiving, by the service platform, the execution result from one or more worker nodes determined based on the calculated computing resource information includes:
allocating, by a manager node, work for running the image to one or more worker nodes that satisfy the computing resource information; and
receiving, by the manager node, the execution result from the one or more worker nodes.

8. The method according to claim 7, wherein
a plurality of worker nodes associated with the manager node includes the one or more worker nodes, and
the allocating, by the manager node, work for running the image to one or more worker nodes that satisfy the computing resource information includes:
allocating, by the manager node, the work to the one or more worker nodes of the plurality of worker nodes based on at least one of communication delay, work performance cost, and reliability of each of the plurality of worker nodes.

9. A computer program stored in a computer-readable recording medium for executing the method according to claim 1 on a computer.

10. A system for providing an interactive computing service for artificial intelligence practice, wherein
the system comprises a user client,
the user client comprises at least one processor, and
the at least one processor includes instructions for:
outputting a plurality of open source codes for artificial intelligence practice;
receiving a request to run one of the plurality of open source codes; and
in response to receiving the request to run, outputting an execution result of the one open source code which is generated by using a container associated with the one open source code.
